(19) United States
(12) Patent Application Publication
(10) Pub. No.: US 2007/0204050 A1
(43) Pub. Date: Aug. 30, 2007

(54) Method Of Radio Access Bearer For Ip Multimedia Session In Umts Network

(76) Inventors: Sheng Liu, Guangdong (CN); Baijun Zhao, Guangdong (CN)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/572,331

(22) PCT Filed: Sep. 18, 2003
(86) PCT No.: PCT/CN03/00791

§ 371 Date: Dec. 14, 2006

(51) Int. Cl. G06F 15/16

(52) U.S. Cl. 709/230

(57) ABSTRACT

A method of Radio Access Bearer for IP Multimedia Session in UMTS Network, including: establishing an IP Multimedia Session between the User Equipment and the IP Multimedia Subsystem; mapping associated SDP parameters into authorized IP QoS parameters, abstracting media IP packet format information from the associated SDP parameters, and transferring, said authorized IP QoS parameters and said media IP packet format information to the GPRS packet data network; mapping said authorized IP QoS parameters into authorized UMTS QoS parameters, and transforming the media IP packet format information into associated messages of RANAP; mapping media characteristics and application demands into UMTS QoS parameters by the User Equipment, and sending them to the GPRS packet data network, to compare the UMTS QoS parameters from the User Equipment with said authorized UMTS QoS parameters, and approving the PDP Context activation or update based on the comparison result by the UMTS Radio Access Network. The method according to the present invention causes the method for implementing Unequal Error Protection to be compliant with the UMTS end-to-end IP QoS structure by using the exiting SBLP-based QoS control mechanism in IMS domain, without modifying the framework of the exiting 3GPP protocol.

### FIELD OF THE INVENTION

The present invention relates to a technique associated with IP Multimedia Subsystem (IMS) in UMTS (Universal Mobile Telecommunication System), and in particular, to a method for implementing an Unequal Error Protection (UEP) of Radio Access Bearer (RAB) for IP Multimedia Session in UMTS system.

### BACKGROUND ART

UMTS (Universal Mobile Telecommunication System) system, is the third generation mobile telecommunication system using WCDMA in wireless techniques, whose standardization has been undertaken by the 3GPP (the Third Generation Partnership Project) organization, and by now four releases have been developed, i.e. Release 99, Release 4, Release 5 and Release 6. In Release 5, a new domain, i.e. the domain of IP Multimedia Subsystem (IMS), is introduced into the UMTS core network over the original underlying domains of Circuit Switch (CS) and Packet Switch (PS).

The IMS domain is a network for providing IP Multimedia Service by implementing IP Multimedia Session call control using IP application-level signaling SIP (Session Initiation Protocol), the core of which is a network element equivalent to a SIP server in function, called Call State Control Function (CSCF). In the IMS domain network structure, the original PS domain core network, i.e. GPRS (General Packet Radio Service) packet data network, is in fact a packet network for providing IP Multimedia Service signaling and user data bearer.

In the current 3GPP specification, CS domain provides a good support to the Unequal Error Protection for the services of session including AMR (Adaptive Multiple Rate) voice service and flow classes. Taking AMR voice service as an example, since the CS domain core network has complete information on AMR voice frame data flow structure, the CS domain core network may specify parameters of the formats of its subflows SDU (Service Data Unit) and the like, when establishing an AMR voice for RAB, thereby to implement an Unequal Error Protection for each subflow on radio interfaces. On the contrast, in an IMS domain, the IP Multimedia Session is established by means of an end-to-end application-level signaling, and the core network element established by RANAP (Radio Access Network Application Protocol) signaling controlling IP Multimedia Session RAB is SGSN (Serving GPRS Support Node), whereas the PS domain core network only provides a packet bearer service for the IMS multimedia service, and SGSN can not directly obtain information concerning media characteristics. Thus, the existing 3GPP protocol specifications can still not implement an Unequal Error Protection mechanism of real-time IP Multimedia Service RAB in IMS domain efficiently.

With respect to above problem, 3GPP documents such as TR 21.877, Tdoc S2-020289 and Tdoc S2-021159 have set forth three implementation schemes. In Scheme 1 as shown in FIG. 12, after application-level signaling call processing, a UE (User Equipment) initiates a PDP Context (Packet Data Protocol Context) or modifies a request. SGSN transmits a RAB allocation or modification instruction through a RANAP signaling to a UMTS Radio Access Network (UTRAN). The UTRAN sends a RB (Radio Bearer) establishment request through RRC (Radio Resource Control) signaling to UE. After receiving this message, the UE adds in a returned response message an IE (Information Element) reflecting media characteristic parameters such as media flow formats, and RNC (Radio Network Controller) can determine new RAB radio parameters with an Unequal Error Protection mechanism based on these parameters. At this time, it is necessary for RNC to re-allocate the established RB.

In Scheme 2, it is set forth in the above-described documents that the IE “Quality of Service” of the PDP Context activation or modification request messages, i.e. “Activate PDP Context Request”, “Modify PDP Context Request” and the like, initiated directly by UE carries parameters reflecting media characteristics such as media flow formats. As shown in FIG. 4, since a multiple-subflow structure is not supported by the IE “Quality of Service” in the current protocol, there is a need to modify the IE.

In Scheme 3 shown in FIG. 13, similar with Scheme 2, the PDP Context activation or modification request messages, i.e. “Activate PDP Context Request”, “Modify PDP Context Request” and the like, initiated directly by UE carry parameters of media characteristics such as media flow formats. However, this scheme does not modify IE “Quality of Service”, but adds a new IE, which acts as a transparent “container” carrying media characteristics. The reason why it is called a transparent “container” is that SGSN does not parse this IE, but simply takes the transparent “container” out of the PDP Context activation or modification messages from UE, and directly copies it into the RANAP messages, i.e. “RAB Allocation Request” or “RAB Modify Request” and the like so as to forward it to RNC, and RNC can parse this transparent “container”, thereby determining RAB radio parameters for supporting an Unequal Error Protection Mechanism.

While the three potential schemes for supporting an Unequal Error Protection Mechanism of the IMS domain service are set forth in the above-mentioned documents, they all have problems in some degree. Scheme 1 directly uses RRC messages to transfer the media characteristic parameters such as media flow formats, which leads to establish a temporary RB firstly and then reconfigure it immediately, thereby causing a waste for radio resources, and the media characteristic parameters such as media flow formats and the like are parameters of different attributes compared with radio characteristics, and the functional framework used in RRC is not consistent with that of the existing protocols. Scheme 2 needs to modify an important IE “Quality of Service” of the signalings associated with the GPRS session management, thereby causing a significant back-compatibility problem. Although Scheme 3 has a less effects on the existing protocol than other schemes, these three schemes all have a common problem that all of them provide media characteristic parameters such as media flow formats and the like depending on the terminal UE rather than the core network, which is not consistent with the functional division of the existing 3GPP protocol architectures, and all of them need to modify the protocol associated with UE, thereby causing a significant back-compatibility problem. The present invention proposes an effective method for supporting an Unequal Error Protection mechanism of the IMS domain service against the above-described problems.

### SUMMARY OF THE INVENTION

In order to perform an Unequal Error Protection mechanism in IMS domain to optimize the QoS of IP Multimedia Service RAB and increase the efficiency of radio resources, the present invention proposes an effective method addressing the above-described problems in the prior art.

According to the present invention, a method of Radio Access Bearer for IP Multimedia Session in Universal Mobile Telecommunication System (UMTS) Network is provided. The UMTS network comprises: a User Equipment (UE), a UMTS Radio Access Network (UTRAN), a GPRS packet data network, and an IP Multimedia Subsystem. The method includes steps of:
establishing an IP Multimedia Session between the User Equipment and the IP Multimedia Subsystem through a SIP/SDP (Session Description Protocol) application-level signaling, and determining associated media characteristics by SIP/SDP negotiation;
the IP Multimedia Subsystem mapping associated SDP parameters into authorized IP QoS parameters, further abstracting media IP packet format information from associated SDP parameters, and transferring, through an interface with the GPRS packet data network, said authorized IP QoS parameters and said media IP packet format information to the GPRS packet data network;
the GPRS packet data network mapping said authorized IP QoS parameters into authorized UMTS QoS parameters, and transforming the media IP packet format information into associated parameters reflecting the media IP packet format information in associated messages of RANAP (Radio Access Network Application Protocol), typically IE “SDU Format Information”;
said User Equipment mapping said negotiation-determined media characteristics and application demands into UMTS QoS parameters, and sending, in Packet Data Protocol Context (PDP Context) activation or update request messages, them to the GPRS packet data network;
comparing, in the GPRS packet data network, the UMTS QoS parameters from the User Equipment with said authorized UMTS QoS parameters, and the UMTS Radio Access Network approving the PDP Context activation or update based on the comparison result.

Thereafter, the GPRS packet data network transfers the associated parameters reflecting the media IP packet format information through a RANAP message to the UMTS radio network, and the UMTS Radio Access Network performs, when establishing a corresponding Radio Access Bearer, an optimization for the RAB based on this information by using an Unequal Error Protection mechanism.

The method according to the present invention overcomes problems of function division being inconsistent with the existing 3GPP protocol architecture caused by providing media characteristic parameters such as media flow format and the like to a RNC depending on the terminal UE rather than the core network and the potential back-compatibility problems, by using the QoS control mechanism in the existing IMS domain to make the method of implementing Unequal Error Protection compliant with the UMTS end-to-end IP QoS structure, without modifying the existing 3GPP protocol architecture.

### BRIEF DESCRIPTION OF THE DRAWINGS

The present invention and the advantages thereof will become more apparent from the following description with reference to the appended drawings, wherein:

FIG. 1 is an illustrative diagram of an IMS domain network structure in UMTS according to the present invention;

FIG. 2 shows a UMTS end-to-end QoS structure;

FIG. 3 is an illustrative diagram for establishing a UMTS bearer service;

FIG. 4 shows a structure of information element “Quality of Service”;

FIG. 5 shows QoS attribute parameters of UMTS bearer service;

FIG. 6 shows an establishment procedure for IP Multimedia Session in IMS domain;

FIG. 7 shows a SDU format of AMR voice RAB;

FIG. 8 is an illustrative diagram of a 12.2 kbps, AMR/RTP/UDP/IPv6 packet structure employing an octet-aligned mode;

FIG. 9 is an illustrative diagram of a 12.2 kbps, AMR/RTP/UDP/IPv6 packet structure employing a bandwidth-efficient mode;

FIG. 10 is an illustrative diagram of Quality of Service parameters of IP Multimedia Service in IMS domain;

FIG. 11 shows a signaling procedure of a method for implementing an Unequal Error Protection of IP Multimedia Session RAB in IMS domain proposed according to the present invention;

FIG. 12 is a RRC—signaling—based scheme of prior art; and

FIG. 13 is a transparent—“container”—based scheme of prior art.

### DETAILED DESCRIPTION OF THE PREFERRED EMBODIMENT

The present invention will be fully described below in connection with the drawings.

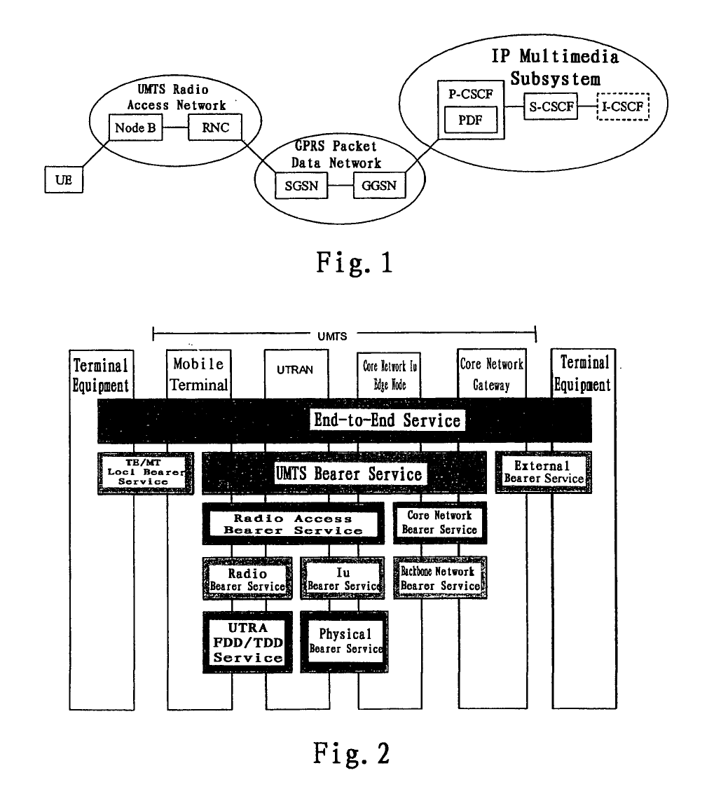

FIG. 1 is an illustrative diagram of an IMS domain network structure in UMTS according to the present invention. In the IMS domain network structure in UMTS shown in FIG. 1, a UE (user equipment) is connected with UTRAN (UMTS Radio Access Network) through an air interface, i.e. Uu interface, wherein UTRAN comprises a Node B and a RNC (Radio Network Controller), an interface between UTRAN and SGSN (Serving GPRS Support Node) is an Iu-PS interface, SGSN and GGSN (Gateway GPRS Support Node) are network elements of a PS domain core network, the interface between which is a Gn interface, and an interface between GGSN and an external Packet Data Network (PDN) is a Gi interface. CSCF generally is divided into three network elements of different function, i.e P-CSCF, S-CSCF, I-CSCF, wherein P-CSCF is connected with GGSN through Gi interface.

In an IMS domain network, P-CSCF is a network element in a visited network that directly makes a SIP signaling interaction with the UE, and functions as a SIP agent server, whose IP address is found in a registration procedure for UE in an IMS network. S-CSCF is a multimedia session master control server for UE in the home network thereof, and is responsible for registration of UE in an IMS network and processes all the service request of UE. I-CSCF is used to mask the IP addresses of individual network elements in IMS domain within an operator network, and acts similar to a firewall in function. With respect to the detailed function descriptions of individual network elements in IMS domain, reference can be make to the document 3GPP TS23.228.

The IMS domain mainly provides IP Multimedia Services of voice, audio, video and the like that require a much higher level of real time. As indicated above, UTRAN and GPRS packet data network provide IP Multimedia Service with SIP signalings and bearer services for user data. Therefore, QoS (Quality of Service) of IP Multimedia Services in IMS domain is closely correlated with QoS of UMTS bearer services. Thereby, the establishments of UMTS bearer service, QoS structure of UMTS bearer service and IP Multimedia Session in IMS domain will be further illustrated below.

In the document 3GPP TS23.107, a UMTS end-to-end QoS structure is defined. FIG. 2 shows a UMTS end-to-end QoS structure. As shown in FIG. 2, UMTS bearer service comprises two sections, i.e. Radio Access Bearer (RAB) service and core network bearer service, and the Radio Access Bearer service in turn comprises radio bearer service and Iu bearer service. For the GPRS packet data network, a UMTS bearer service is also called a GPRS bearer service, one GPRS bearer service corresponding to one PDP Context (Packet Data Protocol Context). A PDP Context is a collection of all the associated information for a UE in one session procedure, and includes information of QoS attribute parameters, PDP classes, PDP addresses allocated to the UEs (i.e. IP addresses for an IP network), gateways connected with the external PDN, and the like.

UMTS supports a plurality of PDP Contexts that use the same PDP address, wherein each PDP Context can have a different QoS requirement. In order to distinguish packets of PDP Contexts of different requirements that have the same address, a TFT (Traffic Flow Template) technique is used in UMTS. TFT is a collection of packet filers, and can distinguish packets of respective PDP Contexts of the same PDP address based on DiffServ code points, IPv6 traffic labels, IP source addresses and the like. TFT is created and managed by UE, wherein uplink TFT is in UE, and downlink TFT is transferred from UE to SGSN through a PDP Context activation or modification procedure.

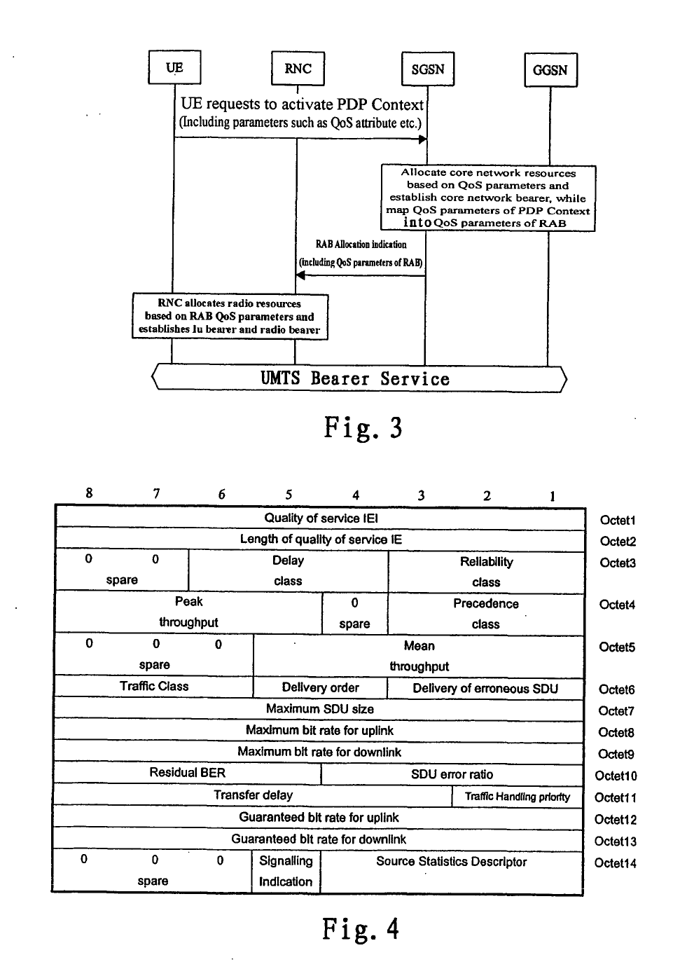

FIG. 3 is an illustrative diagram of an establishment procedure for UMTS bearer service initiated by UE. As shown in FIG. 3, when an application in a UE is to initiate a session, it initiate a request for activating PDP Context through an API (Application Programming Interface) interface to SGSN, with a corresponding message carrying PDP Context associated information of Qos attribute parameters and the like required by the application. SGSN and GGSN allocate resources required by a core network bearer based on the QoS attribute parameters and establish a corresponding core network bearer, wherein SGSN and GGSN can limit the QoS attribute parameters requested by UE based on network capabilities, load conditions, operating policies and the like. In addition, the QoS attribute parameters of PDP Context can also be mapped into corresponding QoS attribute parameters of RAB. Thereafter, a RAB allocating command is initiated by SGSN to RNC, and RNC allocates the required radio resources and establishes a Iu bearer and a radio bearer. As such, a UMTS bearer of an application of the UE is established in the UMTS network. After the UE establishes a first PDP Context by using the signaling “Activate PDP Context Request”, an additional PDP Context of the same PDP address can be established by using signaling “Activate Secondary PDP Context Request”, which signaling includes TFT parameters in addition to the associated information of QoS attribute parameters of the additional PDP Context and the like. Furthermore, for the established PDP Context, the QoS attribute parameters and the like of the PDP Context can be modified by using “Modify PDP Context Request”. With respect to the detailed description of the GPRS session management signaling and procedure, reference can be made to the protocol documents of 3GPP TS23.060, TS24.008 and the like.

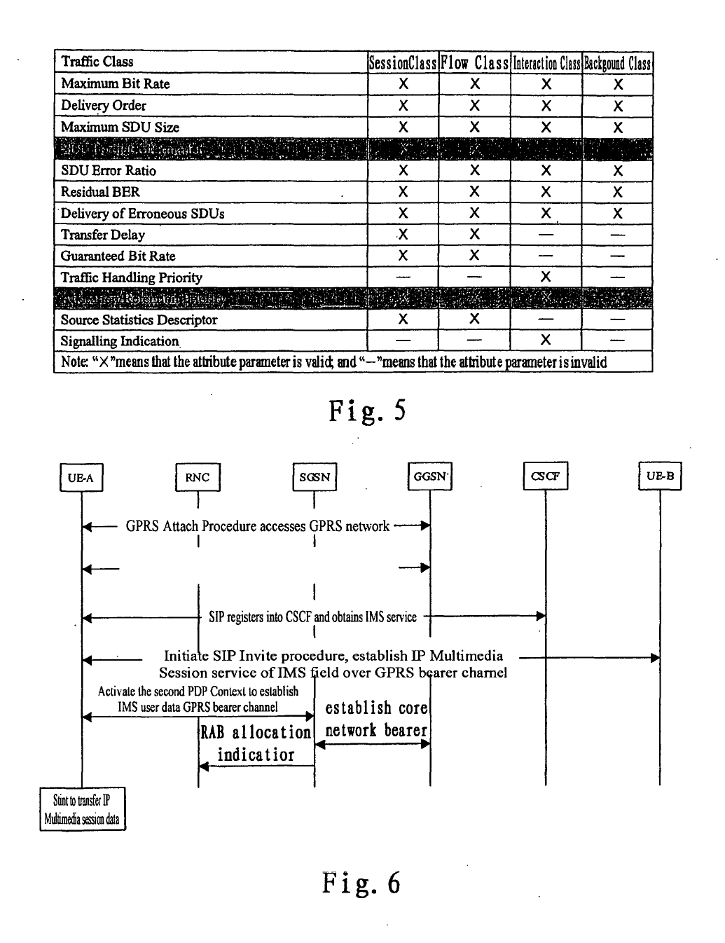

All the above-mentioned GPRS session management messages such as PDP Context activation, modification and the like carry an information element (IE) “Quality of Service” including QoS attribute parameters of the PDP Context, the structure of the information element (IE) “Quality of Service” being shown in FIG. 4. In the figure, Octet represents a group of eight, wherein Octet1˜Octet5 are used for a GPRS network prior to UMTS, and Octet6˜Octet14 are used for UMTS, the respective parameters of which are shown in FIG. 5, and the detailed definitions of which can be referred to the protocol document 3GPP TS23.107. It should be noted that in the QoS attribute parameters of UMTS bearer service shown in FIG. 5, “Service Data Unit Format Information” (“SDU Format Information”) and “Allocation 20/Retention Priority” are not included in the above-mentioned information element “Quality of Service”, because these two parameters are the QoS parameter items of RAB service.

FIG. 6 shows an establishment procedure for IP Multimedia Session in IMS domain. In the establishment procedure for IP Multimedia Session in IMS domain shown in FIG. 6, a UE firstly accesses a GPRS network through a GPRS Attach procedure, then initiates a request for activating a first PDP Context to establish a GPRS bearer path of IMS application-level SIP signaling, and hereafter starts to register into CSCF through SIP signalings to obtain IMS services. After the UE finishes the IMS registration, it can accept a calling or called request of IMS multimedia session at any time, wherein the associated call processes are performed through an end-to-end SIP signaling controlled by CSCF. After a SIP-level call process is finished, a second PDP Context will be activated to establish a GPRS bearer for IP multimedia user data. Because an application-level signaling is of a different QoS attribute as compared with that required by multimedia user data, a plurality of PDP Contexts are needed.

In an initial establishment or reconfiguration procedure of an end-to-end multimedia session in IMS domain, a source encode mode used by media and media characteristics and the like are obtained by an negotiation of end-to-end SIP signalings controlled by CSCF, and in order to prevent an un-authorized using of network resources by a terminal, the control of CSCF can be performed by limiting and authorizing the source encode mode and the media characteristics based on resource conditions, traffic capabilities and operating policies and the like.

In order to further set forth the present invention, a “SDU Format Information” parameter in the above-mentioned QoS attribute parameters of UMTS bearer service will be further described below. As described above, “SDU Format Information” is a QoS parameter item specific to the RAB service, and can be used for services of session and flow classes. According to TS23.107, “SDU Format Information” gives format information of SDU (Service Data Unit) transferred from a core network by RAB, and RNC can perform an Unequal Error Protection (UEP) by using this format information, thereby optimizing the QoS of the RAB and increasing the efficiency of radio resources.

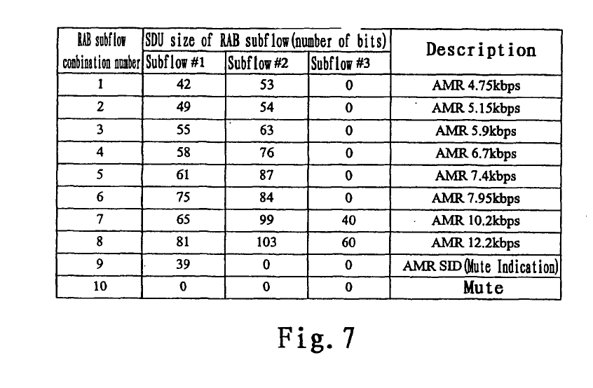

According to the specifications of 3GPP TS23.107 and TS25.413, the QoS parameter item of “SDU Format Information” is sent from a core network through a RANAP (Radio Access Network Application protocol) message of “RAB Allocation Request” to RNC. The IEs carried in the “RAB Allocation Request” message include IE “RAB parameters”, which in fact contains all the QoS attribute parameters of the RAB. IE “SDU parameters” is a sub-level IE of IE “RAB parameters”, and when a data flow sent form a core network through an Iu interface to RNC comprises a plurality of RAB subflows of different QoS requirements, each subflow corresponds to a individual “SDU parameters” parameter item, respectively. The IE includes four sub-level IEs, i.e. “SDU error ratio”, “Residual BER”, “Delivery of Erroneous SDUs” and “SDU format information parameter”, wherein IE “SDU format information parameter” describes the above-described “SDU format information” parameter in the UMTS bearer service QoS attribute parameters. IE “SDU format information parameter” contains two sub-level IE, i.e. “Subflow SDU size” and “RAB Subflow Combination bit rate”, either of or the combination of which can describe format information of RAB, and as to the detailed usage of the two IEs, reference can be made to the specification 3GPP TS25.413. For an AMR (Adaptive Multiple Rate) voice service, “Subflow SDU size” is generally used to describe the SDU format of its RAB, as shown in FIG. 7. RNC implements Unequal Error Protections for different subflows by choosing different radio parameters such as channel encode classes, rate matching attributes and the like, based on different QoS requirements of respective RAB subflows, thereby efficiently using radio resources and ensuring the QoS of RAB services.

Furthermore, in order to better set forth the method of the present invention, in the following, it will take the VoIP service in IMS domain as an example to further describe the RTP packet payload format of AMR voice and the QoS mechanism in IMS domain. Although the Unequal Error Protection of VoIP service is described here as an example, the method and principle set forth by the present invention will be also applicable to other IP real-time multimedia service in IMS domain.

According to the specification 3GPP TS26.236, the transport protocol of VoIP service in IMS domain is RTP (Real-time Transport Protocol)/UDP (User Datagram Protocol)/IP, wherein the IP-layer protocols can using IPv4 or IPv6 versions. According to the specification 3GPP TS26.235, VoIP service in IMS domain employs a narrow-band AMR voice codec or a wide-band AMR (AMR-WB) voice codec, and the data formats of their RTP payload are compliant with the IETF (Internet Engineering Task Force) standard RFC3267. Furthermore, according to the specifications 3GPP TS25.414 and TS25.415, the user plane radio network layer protocol of Iu-PS interface, i.e. Iu UP, employs a transparent mode, and thus the user plane radio network layer protocol of Iu-PS interface is carried by GTP-U (User Plane GPRS Tunneling Protocol) packets, which are the user data packets including the above-described RTP/UDP/IP packet header and the RTP payload, wherein the RTP payload, i.e. the format and structure of AMR or AMR-WB encode data block, is defined as in the IETF specification RFC3267.

According to the IETF specification RFC3267, the AMR or AMR-WB encode data frame carried by RTP comprise three portions, i.e. frame header, content list and voice encode data. This frame format supports two modes, i.e. a bandwidth-efficient mode and an octet-aligned mode, wherein the bandwidth-efficient mode is in a unit of bit, without the need of adding any filling bits, and thus can efficiently utilize the bandwidth in the bandwidth resources limited networks such as a radio network and the like; and the octet-aligned mode is convenient to interconnect with other networks. The RTP payload defined by RFC3267 can, as needed, employ any flexible structure, and the detailed description of the specifically used frame structure is generally a part of the SDP message body, and will be determined by means of an end-to-end negotiation during the SIP signaling procedures such as session establishment and the like.

In fact, a SIP message comprises two portions, i.e. a SIP protocol header and a message body, wherein the SIP protocol header corresponds to the control signalings of session call establishment, termination and modification and the like defined by the SIP protocol, and all the information associated with session and media is described by using the SDP (Session Description Protocol) protocol, and is encapsulated as a message body in the SIP message.

The SDP description is divided into a session-level description and a media-level description, wherein the media description includes information of media classes, encode manners, transport protocols, media formats and the like. As indicated above, all the descriptions associated with an IMS domain VoIP voice data packet format, including the structure and format of the RTP/UDP/IP packet header and the RTP payload portion, are encapsulated in associated SIP messages through the SDP message bodies.

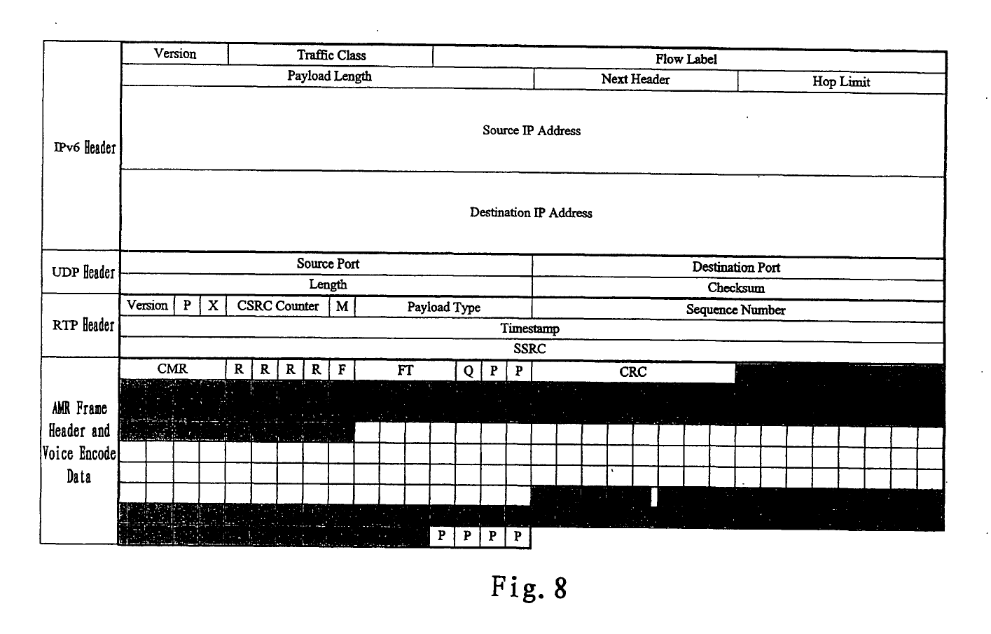

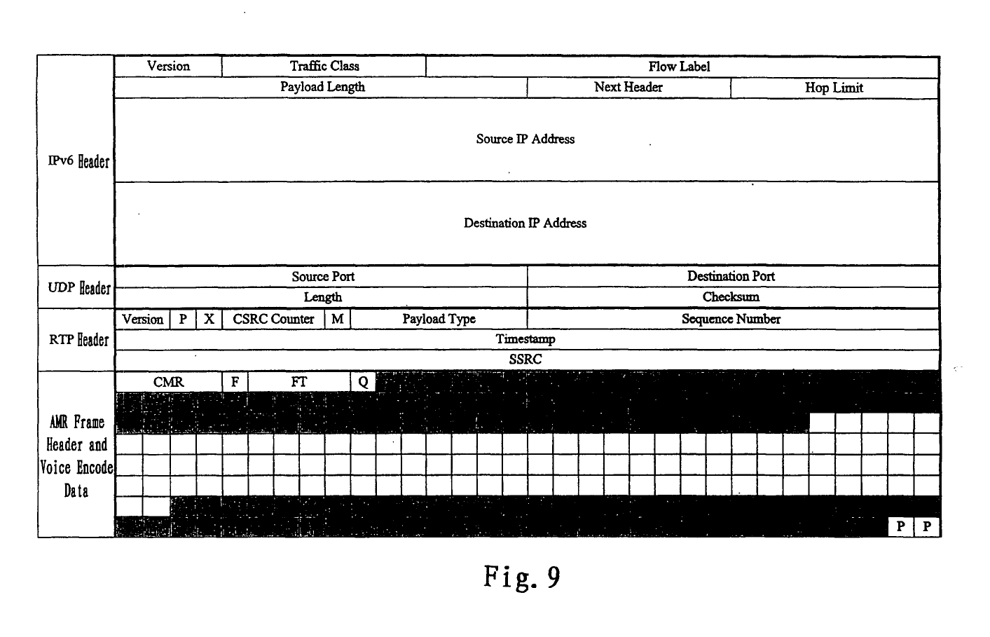

FIGS. 8 and 9 show the typical illustrative diagrams of a AMR voice frame, with a rate of 12.2 kbps, carried by RTP/UDP/IPv6 under these two modes (with respect to the definitions and the functions of the respective fields, reference can be made to the associated technique standards of IETF), respectively. The figures distinguish the three classes of bits A, B, C of an 12.2 kbps AMR voice by using shadows, wherein different classes of encode bits have different importance to the voice decoding, and thus their protection 20 degrees, i.e. QoS requirements, are different. It can be seen that a VoIP packet of IMS domain mainly comprises three classes of data bits, i.e. RTP/UDP/IP packet header, AMR voice frame header and AMR voice encode data, and the AMR voice encode data is in turn divided into different classes of encode bits with different QoS requirement. As indicated above, as long as RNC obtains all the information regarding these formats, it can perform an Unequal Error Protection mechanism for radio performance optimization.

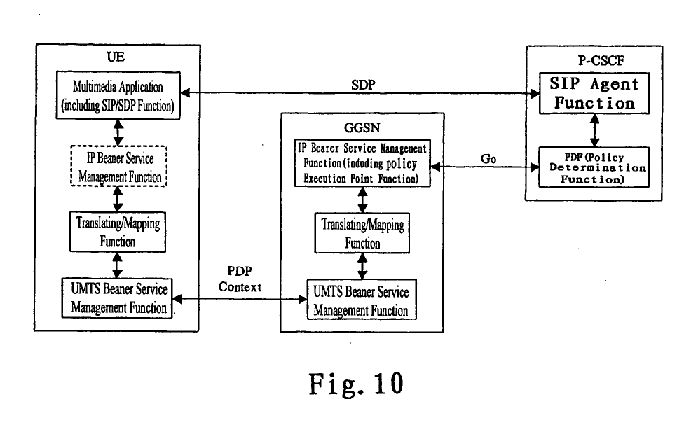

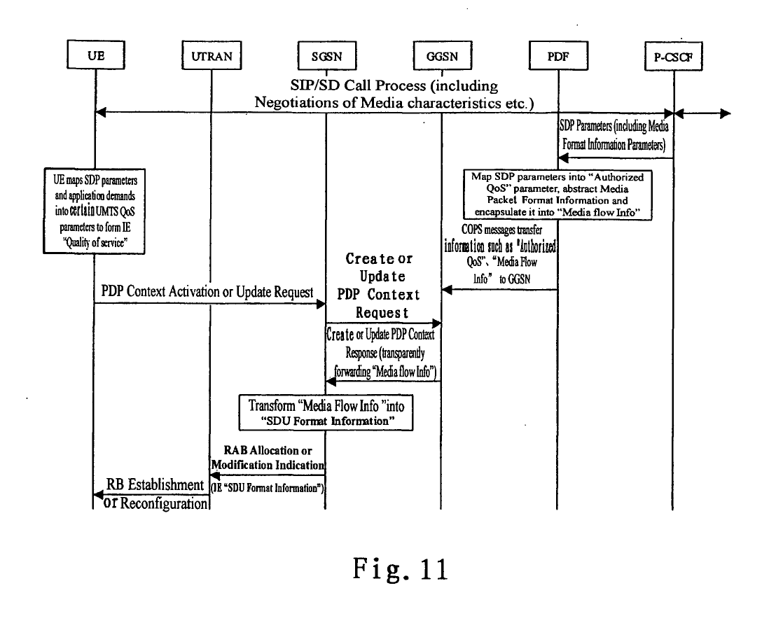

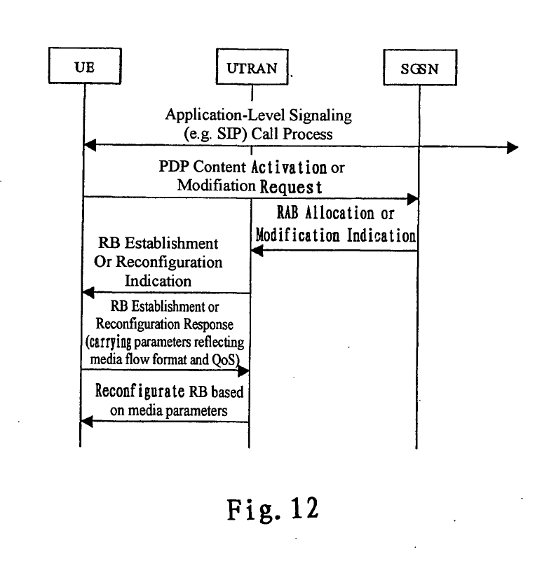

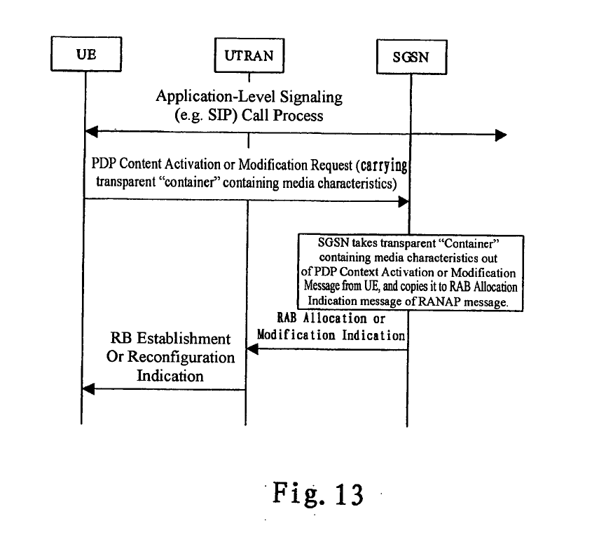

FIG. 10 is an illustrative diagram for mapping Quality of Service parameters of IP Multimedia Service in IMS domain. According to the UMTS end-to-end IP QoS structure given by TS23.207, the QoS of IP Multimedia Service of IMS domain is managed and controlled based on a SBLP (Service-Based Local Policy) technique. In the functional units associated with IP QoS management in UE, GGSN and P-CSCF shown in FIG. 10, the IP bearer service management function unit manages IP bearer service by using a standard IP QoS mechanism, typically including a DiffServ (Differential Service) edge function or a RSVP (Resource Reservation Protocol) function, wherein the IP bearer service management function of UE is optional, the IP bearer service management function of GGSN is compulsive, and in order to support a SBLP-based end-to-end IP QoS management technique, a Policy Execution Point (PEP) function is included. Correspondingly, a PDF (Policy Determination Function) unit is included in P-CSCF, the interface Go between which and GGSN follows the COPS (Common Open Policy Service) protocol of IETF. A translating/mapping function is responsible for the inter-transformation of QoS parameters between a UMTS bearer service and a upper layer. In GGSN, the IP QoS parameters are mapped into required UMTS QoS parameters, and in UE, the QoS parameters of application layer (for example, SDP) or IP layer (for example, RSVP) are mapped into required UMTS QoS parameters.

In the initial establishment or reconfiguration procedure of an end-to-end multimedia session in IMS domain, the media-related characteristics including media classes, encode manners, transport protocols, media formats and the like are determined by an end-to-end SIP/SDP signaling negotiation controlled by CSCF. As shown in FIG. 10, P-CSCF forwards the associated SDP information determined by negotiation to PDF, PDF then maps the associated SDP parameters into authorized IP QoS parameters and transfers them to GGSN through the Go interface, and GGSN in turn maps the authorized IP QoS parameters into authorized UMTS QoS parameters. On the other hand, UE maps the associated SDP parameters and application demands determined by negotiation into certain UMTS QoS parameters, and sends them as IE “Quality of Service” through the PDP Context activation or modification request messages to the PS domain core network. Once GGSN receives the PDP Context activation or modification requests, GGSN compares the “Quality of Service” requested by UE with the corresponding authorized UMTS QoS parameters. If the QoS requests of UE is within the PDF authorization range, the PDP Context activation or modification requests will be accepted; otherwise, they will be rejected.

In the above-described SBLP mechanism, all the interfaces of functional units except the Go interface are implementation-dependent internal interfaces and are not standardized, and only the Go interface is standardized and employs the COPS protocol of IETF standard. COPS is a client/server model-based inquiry and response protocol, which defines a set of standard interface frameworks, allowing user-specific information to be encapsulated in objects without modifying the COPS protocol per se. In the UMTS, the standard COPS messages SSQ, OPN, CAT, CC, KA, SSC and the like are used to establish and maintain the connections between PDF and GGSN. The COPS messages associated with QoS policy control are REQ, DEC, RPT and DRQ. As to the detailed description regarding the COPS protocol, reference can be made to the IETF standard RF2748.

According to the specification 3GPP TS 29.207, in the current protocol, P-CSCF will provide the PDF function unit with the following SDP information in the SIP/SDP messages:
Destination IP address;
Destination Port Number;
Transport Protocol Identification;
Media Direction Information;
Source Direction (initiating part or terminating part);
Indication of Groups which media component belongs to;
Media Class Information;
Bandwidth Parameters;
Forking or Non-forking indication.

In the parameters created by PDF using the above information, the associated IP Quality of Service parameters are transferred to GGSN through the COPS messages of the Go interface, GGSN in turn maps the associated IP Quality of Service parameters into authorized UMTS QoS parameters, and thereby the Policy Execution Point function of GGSN controls the QoS requested by UE. “Authorized QoS” mainly includes two classes of parameters, i.e. data rates for uplink/downlink and the maximum QoS class. With respect to the definitions and values of the above-mentioned SDP parameters, reference can be made to the specification IETF RFC 2327. With respect to the detailed arithmetics for mapping the above-mentioned SDP parameters into “Authorized QoS” parameters, reference can be made to the specification 3GPP TS29.208.

FIG. 11 shows a signaling procedure of a method for implementing Unequal Error Protection of IP Multimedia Session RAB in IMS domain according to the present invention. First, an application-level SIP/SDP call process performs establishment of an IP Multimedia Session, including negotiations of media characteristics such as media codec manners and the like as described in TS23.228 and TS24.228; P-CSCF transfers associated parameters to PDF, and PDF maps the SDP parameters into parameters of “Authorized QoS” and the like. Furthermore, according to the present invention, PDF also abstracts media IP packet format information from the associated SDP parameters and encapsulates it into media flow information (“Media Flow Info”), and then transfers the parameters in the current standard such as “Authorized QoS” and the like and the “Media Flow Info” of the present invention to GGSN by the COPS messages through the Go interface. On the other hand, UE maps the associated SDP parameters and application demands into certain UMTS QoS parameters to form IE “Quality of Service”, and then transfers them by the PDP Context activation or modification request messages to SGSN; and SGSN send to GGSN Gn interface messages such as “Create PDP Context Request”, “Update PDP Context Request” and the like. According to the present invention, GGSN transparently forwards, in the corresponding respond messages, “Media Flow Info” to SGSN; and SGSN transforms “Media Flow Info” into IE “SDU Format Information” in the above-described RANAP-related messages. Thus, SGSN can make RNC establish an optimized RAB with Unequal Error Protection characteristics in UTRAN by a standard Iu interface signaling and mechanism.

From the above, the present invention makes a bit modification to the Gn and Go interface signalings of the existing 3GPP specification, i.e. adding IE “Media Flow Info” into the Gn interface messages “Create PDP Context Response” and “Update PDP Context Response”, and adding “Media Flow Info” into the Go interface message Authorization_Decision (DEC) (PDF->GGSN). The present invention does not need to modify the COPS protocol per se because of the object encapsulation characteristics of COPS.

Because the interface between P-CSCF and PDF is a specific-implementation-dependent internal interface, the present invention does not relate to the modification of the interface. However, in order to enable PDF to abstract the information such as media format and the like to form “Media Flow Info”, according to the present invention, in addition to the SDP parameters provided to PDF by P-CSCF as required in the above-mentioned TS29.207, P-CSCF also provides PDF with the following SDP parameters:
RTP payload format name described by the “a=rtpmap” field in the SDP message body;
RTP payload format MIME (Multipurpose Internet Mail Extensions) encode description described by the “a=fmtp” field in the SDP message body;

In combination with other SDP parameters provided to PDF by P-CSCF in TS29.207, PDF can obtain the media IP packet format information to form the parameter “Media Flow Info”.

The present invention does not impose any limitation on the specific form of the media IP packet format information described by the parameter “Media Flow Info”. Preferably, the media IP packet can be divided into the following sections: RTP/UDP/IP packet header, RTP payload header, and encode bits of different QoS classes in the media data (e.g. three classes of bits A/B/C of a 12.2 kbps AMR), and “Media Flow Info” includes the positions of different sections in an IP packet and the parameters of “SDU error ratio”, “Residual BER”, “Delivery of Erroneous SDUs” and the like of the corresponding sections. The positions of different sections in a IP packet can use a plurality of representation manners, such as the length of each section represented in bits or the distance from the first bit of a packet, and the like, and the QoS parameters of “SDU error ratio”, “Residual BER”, “Delivery of Erroneous SDUs” of each section can be derived by using a certain arithmetic in combination with certain experiential parameters and other SDP parameters.

For the purpose of illustration, the present invention terms the media IP packet format information abstracted from associated SDP parameters by PDF as “Media Flow Info”. However, the present invention does not limit the name of the format information and it can use other names.

Furthermore, although the present invention is described as an example of a UMTS system, the method and principle set forth by the present invention are also applicable to other mobile telecommunication systems, typically such as CDMA2000, GPRS/EDEG and the like.

Although the present invention is described in detail by some exemplary embodiments, various modifications and alternatives can be conceived by those skilled in the prior art. Therefore, the present invention covers all the modifications and alterations within the protection scope of the present invention defined by the appended claims.

1. A method of Radio Access Bearer for IP Multimedia Session in Universal Mobile Telecommunication System (UMTS) Network, the UMTS network comprising: a User Equipment (UE), a UMTS Radio Access Network (UTRAN), a GPRS packet data network, and an IP Multimedia Subsystem, the method including steps of:
establishing an IP Multimedia Session between the User Equipment and the IP Multimedia Subsystem through SIP/SDP application-level signalings, and determining associated media characteristics by SIP/SDP negotiation;
while mapping associated SDP parameters into authorized IP QoS parameters within the IP Multimedia Subsystem, abstracting media IP packet format information from the associated SDP parameters, and transferring, through an interface with the GPRS packet data network, said authorized IP QoS parameters and said media IP packet format information to the GPRS packet data network;
mapping said authorized IP QoS parameters into authorized UMTS QoS parameters by the GPRS packet data network, and transforming the media IP packet format information into associated parameters reflecting the media IP packet format information in associated messages of Radio Access Network Application Protocol (RANAP);
mapping said negotiation-determined media characteristics and application demands into UMTS QoS parameters by said User Equipment, and sending, in Packet Data Protocol Context (PDP Context) activation or update request messages, them to the GPRS packet data network; and
comparing, in the GPRS packet data network, the UMTS QoS parameters from the User Equipment with said authorized UMTS QoS parameters, and approving the PDP Context activation or update based on the comparison result by the UMTS Radio Access Network.

2. The method according to claim 1, wherein the GPRS packet data network transfers the associated parameters reflecting the media IP packet format information in the associated messages of RANAP to the UMTS Radio Access Network, and the UMTS Radio Access Network performs, when establishing a corresponding Radio Access Bearer, an optimization for the Radio Access Bearer (RAB) based on this information by using an Unequal Error Protection mechanism.

3. The method according to claim 2, wherein said associated parameters reflecting the media IP packet format information in the associated messages of RANAP are transferred to the UMTS Radio Access Network through a RANAP message.

4. The method according to claim 1, wherein the associated parameters reflecting the media IP packet format information in the associated messages of RANAP is IE “SDU Format Information” of the associated messages of RANAP.

5. The method according to claim 1, wherein the SDP parameters at least include a Real-time Transport Protocol (RTP) payload format name described by a “a=rtpmap” field in the SDP message body and a RTP payload format MIME encode description described by a “a=fmtp” field in the SDP message body.

6. The method according to claim 5, wherein the abstracting of the media IP packet format information by said IP Multimedia Subsystem is performed by using the Real-time Transport Protocol (RTP) payload format name described by the “a=rtpmap” field in the SDP and the RTP payload format MIME encode description described by the “a=fmtp” field in the SDP and other SDP parameters.

7. The method according to claim 1, wherein the UMTS Radio Access Network includes a Radio Network Controller (RNC), the GPRS packet data network includes a serving GPRS Support Node (SGSN) and a Gate GPRS Support Node (GGSN), the IP Multimedia Subsystem includes a network element P-CSCF, which contains a Policy Determination Function (PDF) unit, a interface between SGSN and GGSN is a Gn interface, and a interface between PDF and GGSN is a Go interface.

8. The method according to claim 7, wherein said UMTS QoS parameters mapped from the User Equipment are sent as information element (IE) Quality of Service through said PDP Context activation or update request messages to SGSN of the GPRS packet data network, and SGSN sends to GGSN the Gn interface messages of “Create PDP Context request” and “Update PDP Context request”.

9. The method according to claim 8, wherein the P-CSCF network element forwards the SDP parameters to the PDF unit in the IP Multimedia Subsystem.

10. The method according to claim 9, wherein mapping of the SDP parameters into the associated Quality of Service parameters and abstracting of the media IP packet format information from the associated SDP parameters are performed by said PDF unit in the IP Multimedia Subsystem, and the PDF unit transfers said media IP packet format information and said associated Quality of Service parameters through the Go interface to GGSN of the GPRS packet data network by using Common Open Policy Service (COPS) messages.

11. The method according to claim 10, wherein GGSN transparently forwards, in Gn interface response message, said media IP packet format information to SGSN, and SGSN transforms said media IP packet format information into the associated parameters reflecting the media IP packet format information in the associated messages of RANAP.

12. The method according to claim 10, wherein the media IP packet format information is added into the Gn interface response message, and the media IP packet format information is added into the Go interface message.

13. The method according to claim 6, wherein the IP packet at least includes one of the following sections: RTP/UDP/IP packet header, RTP payload header and encode bits of different QoS classes in the media data.

14. The method according to claim 6, wherein the media IP packet format information at least includes the positions of different sections in an IP packet and one of the following parameters of the corresponding sections: “SDU error ratio”, “Residual BER”, “Delivery of Erroneous SDUs”.

15. The method according to claim 14, wherein for the positions of different sections in an IP packet, a length of each section or a distance from a first bit of the packet can be represented in bits.

16. The method according to claim 14, wherein said parameters of corresponding sections can be derived from the combination of experiential data and other SDP parameters.

17. A method of Radio Access Bearer for IP Multimedia Session in Universal Mobile Telecommunication System (UMTS) Network, the UMTS network comprising: a User Equipment (UE), a UMTS Radio Access Network (UTRAN), a GPRS packet data network, and an IP Multimedia Subsystem, the UMTS Radio Access Network including a Radio Network Controller (RNC), the method including steps of:
establishing an IP Multimedia Session between the User Equipment and the IP Multimedia Subsystem, and determining associated media characteristics by negotiation;
mapping said negotiation-determined media characteristics into associated Quality of Service parameters within the IP Multimedia Subsystem, and transferring, through an interface with the GPRS packet data network, said Quality of Service parameters to the GPRS packet data network;
mapping said Quality of Service parameters into authorized UMTS QoS parameters by the GPRS packet data network;
mapping said negotiation-determined media characteristics and application demands into UMTS QoS parameters by said User Equipment, and sending, in Packet Data Protocol Context (PDP Context) activation or update request messages, them to the GPRS packet data network;
comparing, in the GPRS packet data network, the UMTS QoS parameters from the User Equipment with said authorized UMTS QoS parameters, and approving the PDP Context activation or update based on the comparison result by the UMTS Radio Access Network,
it is characterized in that,
said associated Quality of Service parameters includes authorized IP QoS parameters and media flow information abstracted from the media characteristic parameters, and
after transferring said media flow information to the GPRS packet data network, said GPRS packet data network transforms the media flow information into associated message of Radio Access Network Application Protocol (RANAP), wherein said message is transferred to RNC for performing an optimization of Radio Access Bearer (RAB) based on this message when establishing corresponding Radio Access Bearer.

18. The method according to claim 17, wherein the message is IE “SDU Format Information”.

19. The method according to claim 17, wherein the establishing of the IP Multimedia Session is performed by using a Session Initiation Protocol/Session Description Protocol (SIP/SDP) call process.

20. The method according to claim 19, wherein said media characteristic parameters are SDP parameters.

21. The method according to claim 20, wherein the SDP parameters at least include a Real-time Transport Protocol (RTP) payload format name described by a “a=rtpmap” field in the SDP message body and a RTP payload format MIME encode description described by a “a=fmtp” field in the SDP message body.

22. The method according to claim 20, wherein said media flow information is formed by abstracting the media IP packet format information from the SDP parameters by said IP Multimedia Subsystem using the Real-time Transport Protocol (RTP) payload format name described by the “a=rtpmap” field in the SDP and the RTP payload format MIME encode description described by the “a=fmtp” field in the SDP and other SDP parameters.

23. The method according to claim 20, wherein the IP packet at least includes one of the following sections: RTP/UDP/IP packet header, RTP payload header and encode bits of different QoS classes in the media data.

24. The method according to claim 23, wherein the media IP packet format information at least includes the positions of different sections in an IP packet and one of the following parameters of the corresponding sections: “SDU error ratio”, “Residual BER”, “Delivery of Erroneous SDUs”.

25. The method according to claim 24, wherein for the positions of different sections in an IP packet, a length of each section or a distance from a first bit of the packet can be represented in bits.

26. The method according to claim 6, wherein the UMTS Radio Access Network includes a Radio Network Controller (RNC), the GPRS packet data network includes a serving GPRS Support Node (SGSN) and a Gate GPRS Support Node (GGSN), the IP Multimedia Subsystem includes a network element P-CSCF, which contains a Policy Determination Function (PDF) unit, a interface between SGSN and GGSN is a Gn interface, and a interface between PDF and GGSN is a Go interface.

27. The method according to claim 26, wherein said UMTS QoS parameters mapped from the User Equipment are sent as information element (IE) Quality of Service through said PDP Context activation or update request messages to SGSN of the GPRS packet data network, and SGSN sends to GGSN the Gn interface messages of “Create PDP Context request” and “Update PDP Context request”.

28. The method according to claim 27, wherein the P-CSCF network element forwards the SDP parameters to the PDF unit in the IP Multimedia Subsystem.

29. The method according to claim 28, wherein mapping of the SDP parameters into the associated Quality of Service parameters and abstracting of the media IP packet format information from the associated SDP parameters are performed by said PDF unit in the IP Multimedia Subsystem, and the PDF unit transfers said media IP packet format information and said associated Quality of Service parameters through the Go interface to GGSN of the GPRS packet data network by using Common Open Policy Service (COPS) messages.

30. The method according to claim 29, wherein GGSN transparently forwards, in Gn interface response message, said media IP packet format information to SGSN, and SGSN transforms said media IP packet format information into the associated parameters reflecting the media IP packet format information in the associated messages of RANAP.

31. The method according to claim 30, wherein the media IP packet format information is added into the Gn interface response message, and the media IP packet format information is added into the Go interface message.
